(19) United States
(12) Patent Application Publication
(10) Pub. No.: US 2011/0009610 A1
(43) Pub. Date: Jan. 13, 2011

(54) Process For The Acetylation Of Lignocelluloses, Hemicelluloses, and Celluloses With Ketene

(75) Inventors: Hermann Petersen, Burghausen (DE); Gerald Fleischmann, Burghausen (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/831,368

(22) Filed: Jul. 7, 2010

(30) Foreign Application Priority Data
Jul. 10, 2009 (DE) 10 2009 027 635.1

(51) Int. Cl. C08B 3/06

(52) U.S. Cl. 536/69

(57) ABSTRACT

The invention relates to a process for acetylating celluloses, lignocelluloses and hemicelluloses such as wood, straw and cotton, and regenerated celluloses produced from natural products, by means of ketene.

### CROSS-REFERENCE TO RELATED APPLICATIONS

This application claims priority to German Patent Application No. DE102009027635.1 filed Jul. 10, 2009 which is herein incorporated by reference.

### BACKGROUND OF THE INVENTION

1. Field of the Invention

The invention relates to a process for acetylating celluloses, lignocelluloses and hemicelluloses, such as wood, straw and cotton, by means of ketene.

2. Background Art

Acetylated lignocelluloses, hemicelluloses and celluloses, such as wood, straw and cotton, have valuable properties, for example, resistance to weathering, resistance to microorganisms such as rot fungi, molds and bacteria, and high dimensional stability in comparison with the unacetylated natural products. Acetylated celluloses (e.g. artificial silk) are also valuable plastics which, in comparison with cellulose, etc., have water-repellent properties and resistance to microbial attack.

Mixed with thermoplastics, thermosetting plastics and elastomers, these acetylated products can be further processed to give composite materials. They are thus economical alternatives to plastics and are based on renewable raw materials. For example, by addition of adhesives, chipboards and MDF boards can also be produced from these products. Moreover, they are suitable as fillers and reinforcing materials in combination with further organic and inorganic materials. The substantially better compatibility of the previously mentioned acetylated products with plastics has numerous advantages, such as improved mechanical strength or reduced water absorption. In addition, the otherwise usual adhesion promoters can be dispensed with. Fibers comprising celluloses, hemicelluloses or regenerated celluloses exhibit a water-repellent effect with otherwise almost unchanged fiber properties after surface acetylation.

In general, the acetylation of solid wood, woodchips or wood flour by means of acetylating agents such as acetic anhydride and isopropenyl acetate has been known for a relatively long time. Likewise, acetylations of straw and cotton are described in the prior art.

In the industrial acetylation of lignocelluloses, hemicelluloses, and celluloses, acetic anhydride has become established commercially as an acetylating reagent. The complete acetylation in the case of solid wood, and the ready availability of the reagent in industry, since it is produced in large amounts and additionally has relatively high reactivity even below the boiling point, are advantageous with respect to the use of acetic anhydride.

A disadvantage of the use of acetic anhydride as an acetylating reagent is, however, the inevitable formation of an unnecessary stoichiometric amount of acetic acid and the subsequent technical complexity of completely removing the acetic acid formed from the wood after the acetylation is ended.

However, the disadvantages described do not exist, for example, in the case of the acetylation of wood by means of highly reactive, gaseous ketene as an acetylating reagent.

JP 2235705 discloses a process for acetylation in which dried solid wood (thickness 15 mm) is reacted by means of ketene gas under pressure (10 bar) or with a solution of ketene gas in acetone (12 bar). The high pressure in this acetylation is necessary because otherwise only thin wood layers (a few mm) could be acetylated throughout. However, a disadvantage of this process is that ketene under pressure easily forms dark-colored polymeric products. Furthermore, very great technical complexity is required in order to ensure the tightness of the pressure system since ketene is very toxic and it is therefore a very high safety risk in the event of leaks.

JP 435903 discloses a process for the acetylation of wood veneers by means of ketene and ketene solutions. In the embodiments, acetylation of relatively thick wood boards having a thickness of 5 mm and acetylation of wood flour by means of a solution of toluene and ketene at atmospheric pressure are described. Furthermore, the acetylation of very thin wood veneers (0.1 mm thickness) at atmospheric pressure and a temperature of 20° C. with ketene gas is described. A disadvantage of the acetylation of wood flour by means of a ketene dissolved in a solvent is the additional effort required for solvent recycling and complete removal of the solvent from the wood flour.

### SUMMARY OF THE INVENTION

The object of the invention was therefore to provide a process for the economical production of acetylated lignocelluloses such as woodchips or wood flour, hemicelluloses such as straw, and celluloses such as cotton fibers, having different degrees of acetylation and for the modification or surface modification of regenerated celluloses for the production of composites, which process processes in the absence of solvent and hence makes the subsequent isolation of the reaction products and additional purification processes unnecessary.

### DETAILED DESCRIPTION OF THE PREFERRED EMBODIMENT(S)

The invention thus relates to a process for the production of acetylated natural products, characterized in that a natural product containing one or more substances from the group of the celluloses, lignocelluloses, hemicelluloses or a material produced from natural products and selected from the group of regenerated celluloses is reacted with ketene gas.

In particular cellulose and cellulose-containing products, for example woods of any type (e.g. beech, coniferous woods, eucalyptus, stone pine), in the form of solid wood or wood in comminuted form such as woodchips, or wood in fibrous or pulverulent form, are suitable for acetylation according to the invention. In addition, the process of the invention can also be applied to wood in the form of workpieces or finished products such as window frames. Furthermore, any form of straw (wheat, rice, rye), fibers from cotton, jute, flax (linen), hemp and sisal, and fibers from regenerated celluloses, for example, viscose, cupro, lyocell, and modal, are suitable.

The process is particularly suitable for acetylating natural compounds containing varying proportions of cellulose, hemicellulose and lignin, for example, wood.

The acetylated natural products obtained according to the invention are suitable in particular for processing to give composites. These may be, for example, composite materials comprising wood fibers or wood particles in a plastic matrix (generally thermoplastics). These are also referred to as wood-plastic composites (WPC). In this procedure, the acetylated natural products are introduced into a plastic melt, for example, PE, PP or PVC, and uniformly distributed. After cooling, a solid composite is obtained and, for example, can be converted by means of injection molding or extrusion into moldings. Such moldings with natural products are distributed as marketable products, for example as window profiles, as chairs, or as profiled floor covering for patios.

In a particular embodiment, composites can also be directly acetylated. Naturally occurring composites or even industrially produced composites can be used for this purpose.

The acetylation according to the invention can be operated batchwise or continuously. A pressure of 0.1 bar to 10 bar and a temperature of 30-180° C. is preferred. The process at a pressure close to atmospheric pressure or at reduced pressure is particularly preferred.

If the process is carried out batchwise, for example, it is possible to use a reactor which has a suitable mixing system and in which ketene gas is passed in via a bottom valve, a gas inlet pipe or via a mixer (e.g. gas dispersion stirrer). The material to be acetylated (e.g. woodchips) is introduced into the reactor and the material to be acetylated is heated to 50-80° C. with continuous or batchwise thorough mixing and ketene gas is then fed in. Alternatively, the starting material may also be introduced in already preheated form into the reactor.

During the feeding of the ketene gas, reaction heat is liberated and is removed via an internal coil or cooling jacket temperatures less than or equal to 150° C. leading to less damage or less discoloration of the material to be acetylated. High temperatures are preferred since the acetylation reaction then takes place particularly rapidly and the temperature difference relative to the cooling medium is great. At temperatures greater than 150° C., a clearly visible discoloration of the material gradually occurs. The reaction with ketene gas can also be effected at lower temperatures, such as room temperature, but this is not economically expedient owing to the low reaction rate.

The ketene feed rate can remain constant during the reaction or can be reduced with time in order to minimize losses via the waste gas. In order to control the reaction, the ketene gas can, if required, also be mixed with an inert gas such as nitrogen, or with noble gas or carbon dioxide prior to use.

The degree of acetylation is regulated via the amount of ketene fed in. As soon as the amount of ketene required for the desired degree of acetylation has been fed in, the feed is stopped and, after a short postreaction time, cooling is effected. Before removal of the finished product, the reactor is optionally evacuated in order to remove traces of remaining ketene gas.

In the case of woodchips or wood flour, materials having a degree of acetylation (WPG %=weight percent gain) up to more than 35% are obtained in this way. The degrees of acetylation in the case of the surface modification of cotton or materials comprising regenerated cellulose correspond to a WPG of up to 10%.

In a particular embodiment of the process according to the invention, it is also possible to use a cascade of reactors in which the ketene-containing waste gas of one reactor is passed into another reactor which is filled with fresh or only partly acetylated material in order to completely utilize remaining ketene in the waste gas.

The process according to the invention can also be effected by means of continuous feeding of the material to be acetylated and continuous removal of the acetylated materials.

In the acetylation of fibers, woven fabrics or composites, an inert gas can also optionally be fed in during the reaction for controlling the reaction temperature and the acetylation rate. Suitable inert gases are, for example, nitrogen, noble gases, carbon dioxide or mixtures thereof.

A continuous procedure in which, for example, a moving-bed reactor, a fluidized-bed reactor or a rotating-tube reactor (as described in EP 0135078) with or without wall recess elements or internals is used, is particularly preferred. The conditions can be chosen so that a constant temperature is established during the acetylation and the acetylation material is discharged at a constant rate. The quantity of heat liberated is removed from the system by means of suitable cooling and can also be used for drying the material fed in, so that the energy consumption of the overall process is minimal.

A starting material having a lower residual moisture content is preferably used. This can be obtained beforehand, for example, by suitable drying processes. Material having a higher residual moisture content can also be used but has the disadvantage that, owing to the formation of acetic acid, a certain degree of agglomeration of the acetylated product cannot be prevented and moreover the acetic acid has to be removed from the acetylated material at the end of the reaction.

The acetylated renewable raw materials thus produced can, for example, be used together with polymers for the production of composite materials which are distinguished by high resistance even under humid conditions or frequent changes of weather. Furthermore, they can also be widely used as fillers.

The surface modification of fibers, woven fabrics, etc. also permits permanent hydrophobization and a change in the mechanical properties. Natural fibers which can be acetylated according to the invention are, for example, wood, straw, flax, hemp and sisal fibers.

The invention is to be explained in more detail with reference to the following examples.

### Example 1

375 g of dried woodchips Lignocel BK 40/90 (from Rettenmaier & Söhne) having a residual moisture content of 0.82% were introduced into a 21 three-necked flask having a gas inlet tube, condenser, thermometer and KPG stirrer with Teflon blade and were heated to 80° C. by means of a heating bath and ketene gas was passed in for 70 min at 100 g/h with stirring. During the introduction, the temperature increased and was capped below 130° C. by cooling. Thereafter, evacuation was effected briefly and the chips were dried overnight in vacuo at 110° C. 441.9 g of acetylated woodchips which had scarcely changed in color and had a residual moisture content of 0.8% and a WPG of 17.9% were obtained.

### Example 2

The procedure in example 1 was adopted—except that ketene gas was passed in for 30 min at 100 g/h, then for 20 min at 75 g/h and for 20 min at 50 g/h. 439.2 g of woodchips which had scarcely changed in color and had a residual moisture content of 0.7% and a WPG of 17.3% were obtained.

### Example 3

The procedure in example 1 was adopted—except that preheating to 40° C. was effected and ketene gas was then passed in at 50 g/h for 100 min. The temperature was then increased to the maximum temperature of 80° C. by the heat of reaction evolved and was kept at this level. 445.7 g of woodchips which had scarcely changed in color and had a residual moisture content of 0.6% and a WPG of 19.1% were obtained.

### Example 4

30 g of dried woodchips Lignocel BK 40/90 having a residual moisture content of 0.82% were introduced into a 250 ml three-necked flask having a gas inlet tube, condenser, thermometer and KPG stirrer having glass paddle stirrer element and ketene gas was passed in at room temperature for 20 min at 20 g/h with stirring. During the introduction, the temperature increased to 90° C. Thereafter, evacuation was effected briefly and the chips were dried overnight in vacuo at 110° C. 32.6 g of acetylated woodchips which had not changed in color and had a residual moisture content of 0.6% and a WPG of 8.9% were obtained.

### Example 5

30 g of dried woodchips Lignocel BK 40/90 having a residual moisture content of 0.82% were introduced into a 250 ml three-necked flask having a gas inlet tube, condenser, thermometer and KPG stirrer having glass paddle stirrer element and ketene gas was passed in at room temperature for 60 min at 20 g/h with stirring. During the introduction, the temperature increased to not more than 117° C. Thereafter, evacuation was effected briefly and the chips were dried overnight in vacuo at 110° C. 39.2 g of acetylated woodchips which had a slightly darker color and had a residual moisture content of 0.5% and a WPG of 31.0% were obtained.

### Example 6

20 g of dried wheat straw having a residual moisture content of 0.33% were introduced into a 500 ml three-necked flask having a gas inlet tube, condenser, thermometer and KPG stirrer having glass paddle stirrer element and ketene gas was passed in for 20 min, beginning at 62° C., at 50 g/h with stirring. During the introduction, the temperature increased to not more than 120° C. Thereafter, evacuation was effected briefly and the chips were dried overnight in vacuo at 110° C. 27.82 g of acetylated straw which had virtually no change in color and had a residual moisture content of 0.4% and a WPG of 39.0% were obtained.

### Example 7

10 g of cotton fibers having a residual moisture content of 6.1% were introduced into a 1000 ml three-necked flask having a gas inlet tube, condenser and thermometer and ketene gas was passed in for 30 min beginning at 55° C., at 20 g/h. During the introduction, the temperature increased to not more than 72° C. Thereafter, evacuation was effected briefly and the fibers were dried overnight in vacuo at 110° C. 10.6 g of acetylated cotton fibers which had not changed in color and had a residual moisture content of 4.1% and a WPG of 8.3% were obtained.

### Example 8

10 g of viscose fibers having a residual moisture content of 9.5% were introduced into a 1000 ml three-necked flask having a gas inlet tube, condenser and thermometer and ketene gas was passed in for 30 min beginning at 58° C., at 20 g/h. During the introduction, the temperature increased to not more than 70° C. Thereafter, evacuation was effected briefly and the fibers were dried overnight in vacuo at 110° C. 9.8 g of acetylated viscose fibers which had not changed in color and had a residual moisture content of 3.5% and a WPG of 4.5% were obtained.

### Example 9

20 g of sisal fibers (about 15-20 mm length) having a residual moisture content of 2.3% were introduced into a 1000 ml three-necked flask having a gas inlet tube, condenser, thermometer and KPG stirrer having Teflon blade stirrer element and ketene gas was passed in for 30 min, beginning at 60° C., at 50 g/h with stirring. During the introduction, the temperature increased to not more than 75° C. Thereafter, evacuation was effected briefly and the fibers were dried overnight in vacuo at 110° C. 20.9 g of acetylated sisal fibers which had changed only slightly in color and had a residual moisture content of 1.5% and a WPG of 5.4% were obtained.

### Example 10

100 g/h of woodchips (Lignocel BK 40/90, dried) and 27 g/h of ketene gas were introduced continuously into a laboratory rotating-tube reactor and the acetylated woodchips were removed continuously, the ketene gas flowing countercurrent to the wood particles and the temperature of the chips being increased by heating/cooling at 115-125° C. The average residence time was 30 min. After 2 h at constant ratios, 235.1 g of acetylated woodchips which had not changed in color and had a WPG of 17.9% were obtained.

### Example 11

200 g/h of woodchips (Lignocel BK 40/90, dried) and 40 g/h of ketene gas together with 500 ml/min of nitrogen gas heated to 110° C. were introduced continuously into a laboratory fluidized-bed reactor and acetylated woodchips were removed continuously. The average residence time was 30 min. The acetylated woodchips are unchanged in color and the WPG is 16.2%.

### Comparative Example 1

A white ash board having a thickness of 15 mm, width of 150 mm and length of 300 mm was dried in a vacuum drying unit at 100° C. for 5 hours. Ketene gas was then passed in, the pressure being adjusted to 10 atmospheres and reaction being effected at 100° C. for 2 hours. The excess ketene gas was then converted into acetic acid by passage into water. The weight increase was 20%.

### Comparative Example 2

100 g of Lauan wood flour are introduced into a pressure-resistant 5 l glass vessel and degassed in vacuo to 100 mmHg. Thereafter, toluene is introduced, atmospheric pressure is restored by introduction of air and ketene gas is fed in at 20 ml/min for 60 minutes for acetylation.

After the end of the reaction, the toluene is removed and the Lauan wood flour is isolated. The weight increase of the wood as a result of the acetylation is 18%.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A process for the production of acetylated natural products, comprising acetylating by reacting ketene gas with a natural product comprising one or more substances selected from the group consisting of cellulose, lignocellulose, hemicellulose and regenerated cellulose, acetylating taking place at about atmospheric pressure or below atmospheric pressure.

2. The process of claim 1, wherein wood in the form of solid wood or in comminuted form used as chips, fibers, powder is acetylated.

3. The process of claim 2, wherein wood in comminuted form comprises chips, fibers, powder, or a mixture thereof

4. The process of claim 1, wherein one or more of straw from wheat, rice or rye, fibers from cotton, jute, flax (linen), hemp or sisal, and fibers from regenerated celluloses are acetylated.

5. The process of claim 1, wherein a composite is acetylated.

6. The process of claim 1, wherein acetylating is batchwise or continuous.

7. The process of claim 1, wherein reacting is carried out with pure ketene gas or a ketene/inert gas mixture.

8. The process of claim 1, wherein acetylating takes place at a pressure of 0.1 bar to 10 bar and a temperature of 30-180° C.

9. The process of claim 1, wherein a degree of acetylation is regulated via the amount of ketene fed to a reactor in which acetylating takes place.

10. The process of claim 1, wherein the natural product is subjected to a drying process before acetylating.

11. The process of claim 1, which takes place at 0.1 bar to 1 bar.

12. The process of claim 1, which takes place at a temperature below 150° C.

13. The process of claim 1, which is free of organic solvent.

14. The process of claim 1, wherein a cooled reactor is employed for acetylating.

15. The process of claim 14, wherein the acetylating takes place at a temperature higher than room temperature, the temperature being established by a heat of reaction of acetylating, and the temperature kept below 150° C. by removing excess heat by cooling.
